(19) United States
(12) Patent Application Publication
(10) Pub. No.: US 2020/0335778 A1
(43) Pub. Date: Oct. 22, 2020

(54) Core-shell Nanoparticles and Their Use in Electrochemical Cells

(71) Applicants: Agency for Science Technology and Research, Singapore (SG); Hydro-Québec, Montreal (CA)

(72) Inventors: Jackie Y. YING, Singapore (SG); Jinhua YANG, Singapore (SG); Karim ZAGHIB, Montreal (CA); Michel L. TRUDEAU, Montreal (CA)

(21) Appl. No.: 16/956,804

(22) PCT Filed: Dec. 21, 2018
(86) PCT No.: PCT/SG2018/050625

§ 371 Date: Jun. 22, 2020

(30) Foreign Application Priority Data
Dec. 22, 2017 (SG) 10201710771Q

(51) Int. Cl. H01M 4/50; H01M 4/36; H01M 4/38; H01M 4/62; H01M 10/0525

(52) U.S. Cl. CPC H01M 4/50; H01M 4/366; H01M 4/364; H01M 2004/028; H01M 4/625; H01M 4/623; H01M 10/0525; H01M 4/38

(57) ABSTRACT

Here are described core-shell nanoparticles comprising a porous core, a shell layer and sulfur diffused through the pores of the porous core, their use in electrode materials as well as their methods of preparation. Also described are composite materials, electrode materials, electrodes, and electrochemical cells comprising the core-shell nanoparticles and their use in lithium sulfur batteries.

### RELATED APPLICATION

This application claims priority under applicable laws and regulations to Singapore application No. 10201710771Q filed on Dec. 22, 2017, the content of which is incorporated herein by reference in its entirety for all purposes.

### TECHNICAL FIELD

The technical field generally relates to electrode materials comprising core-shell nanoparticles (NPs), their methods of synthesis and use in lithium-sulfur (Li—S) electrochemical cells.

### BACKGROUND

A lithium-sulfur (Li—S) battery generally comprises a lithium metal anode, a cathode comprising elemental sulfur (S₈) and an electrolyte. Lithium-sulfur batteries are within the most promising candidates for satisfying emerging market demands. Indeed, Li—S batteries offer a theoretical capacity and an energy density of 1,675 mA h g⁻¹ and 2,500 kW kg⁻¹ respectively, through their multielectron redox reaction illustrated by the equation 16Li+S₈→8 Li₂S. Moreover, sulfur has a very high natural and synthetic abundance. The synthetic abundance is attributed to the fact that sulfur is a by-product of petroleum refining.

However, the practical applications of lithium-sulfur batteries are hindered predominantly by the sulfur particles' poor electronic conductivity, the dissolution of intermediate polysulfides (Li₂Sₓ, where 3<x≤8) into the electrolyte, and the large volumetric expansion (˜80%) upon lithiation, which result in a capacity fading and a low Coulombic efficiency. Once dissolved, Li₂Sₓ species are involved in a phenomenon called “shuttle effect” which destabilizes the lithium surface. This phenomenon also plays a key role in reducing the battery stability and its low coulombic efficiency.

Extensive efforts have been devoted to improving the electronic conductivity of sulfur particles and to reduce the Li₂Sₓ “shuttle effect” in order to improve long-term cycling performances of Li—S batteries. One of the proposed strategies is to encapsulate sulfur particles in porous conductive materials such as carbon, graphene oxide and/or a conductive polymer. However, none of these has been found optimal to prevent Li₂Sₓ dissolution. Structured metal oxides, metal nitrides, metal carbides and chalcogenides have also been extensively studied as host materials due to their strong chemical interactions with dissolved Li₂Sₓ. Indeed, they were found to significantly improved the cell's lifetime. However, these materials are known for their low electronic conductivity and therefore impeded the electron transport pathway, resulting in low sulfur utilization and poor cycling stability. Considerable efforts have also been made to tackle the third challenge (i.e. the volumetric expansion upon lithiation). One of the proposed strategies is the encapsulation of sulfur particles in composites with core-shell morphology. Using this approach significantly improved cycling stability and efficiency were obtained, but there is still room for improvement.

There is thus a need alternative and complementary technological approaches for improving the long-term cycling performance of Li—S batteries.

### SUMMARY

According to one aspect, the present application relates to core-shell nanoparticles comprising a porous metal oxide core of formula M_{y}Oₓ, wherein M defines at least one transition metal, y is an integer selected from 1 to 4, and x is an integer selected from 1 to 8, x and y being selected to achieve electroneutrality; elemental sulfur (S₈) as an electrochemically active material, the elemental sulfur being incorporated into the pores of the metal oxide core; and an outer shell surrounding the core, the outer shell comprising TiO₂. In one embodiment, M is Mn, Fe, Co, Ni, Zn or a combination thereof, y is an integer from 1 to 3; and x is an integer from 1 to 7. In a preferred embodiment, M is Mn, preferably M_{y}Oₓ is MnO. In a further embodiment, the M:Ti molar ratio is of about 10:1 to about 0.5:1, or about 4:1 to about 0.7:1, preferably about 3:1 to about 0.7:1 and most preferably about 2:1 to about 0.8:1.

According to another aspect, there is provided a nanocomposite material comprising the core-shell nanoparticles as defined herein and a first conductive nanomaterial. In one embodiment, the core-shell nanoparticles are supported on the first conductive material, for instance, the latter being a nanocarbon nano-wire, nano-sheet, nano-belt, or a combination thereof.

According to another aspect, there is provided a method for producing core-shell nanoparticles or a nanocomposite material as herein defined, the method comprising: (a) contacting M_{y}(CO₃)ₓ nanoparticles with TiO₂ or a TiO₂ precursor to form TiO₂ coated M_{y}(CO₃)ₓ nanoparticles (M_{y}(CO₃)ₓ/TiO₂); (b) thermally treating the M_{y}(CO₃)ₓ/TiO₂ nanoparticles from step (a) at elevated temperature under inert gas to form core-shell M_{y}Oₓ/TiO₂ nanoparticles; (c) optionally thermally treating the core-shell M_{y}Oₓ/TiO₂ nanoparticles with a first conductive nanomaterial under inert gas at elevated temperature, optionally in the presence of hydrogen gas, to form a nanocomposite material; (d) optionally partly removing M_{y}Oₓ after step (b) or (c) by treatment with an acid; (e) milling the obtained nanoparticles or nanocomposite material of step (b), (c) or (d) with elemental sulfur (S₈) to produce a mixture; and (f) heating the mixture obtained in step (f) at elevated temperature under inert gas to cause the sulfur to melt-diffuse into the into the pores of the nanoparticles and/or nanocomposite material.

According to yet a further aspect, there is provided a method for producing nanoparticles or a nanocomposite material as herein defined, the method comprising: (a) synthesizing MnCO₃ nanoparticles by a microemulsion-mediated solvothermal reaction; (b) reacting the MnCO₃ nanoparticles from step (a) in a polar solvent with a TiO₂ precursor, preferably an organotitanium compound, to produce MnCO₃/TiO₂ nanoparticles; (c) thermally treating the MnCO₃/TiO₂ nanoparticles at elevated temperature under inert gas to produce core-shell MnO/TiO₂ nanoparticles; (d) optionally thermally treating the core-shell MnO/TiO₂ nanoparticles with a first conductive nanomaterial under inert gas at elevated temperature, optionally in the presence of hydrogen gas, to form a nanocomposite material; (e) optionally partly removing MnO after step (c) or (d) by treatment with an acid; (f) milling the nanoparticles or nanocomposite obtained in step (c), (d) or (e) with elemental sulfur to produce a mixture; and (g) heating the mixture obtained in step (f) at elevated temperature under inert gas to cause the sulfur to melt-diffuse into the nanocomposite.

According to another aspect, the present technology also contemplates the core-shell nanoparticles or nanocomposite material obtained by a method as herein defined.

According to a further aspect, the present application relates to an electrode material comprising the core-shell nanoparticles or nanocomposite material as defined herein.

According to yet another aspect, the present application relates to a positive electrode comprising the electrode material as defined herein on a current collector.

According to another aspect, the present application relates to an electrochemical cell comprising the positive electrode as defined herein, a negative electrode and an electrolyte.

According to another aspect, the present application relates to a lithium sulfur battery comprising at least one electrochemical cell as defined herein.

According to another aspect, the present application relates to a lithium sulfur battery comprising the core-shell nanoparticles or nanocomposite material as defined herein.

According to a further aspect, the present application relates to the use of the core-shell nanoparticle as defined herein in a lithium sulfur battery.

According to yet a further aspect, the present technology also contemplates the use of a lithium sulfur battery as herein defined in mobile devices, for example mobile phones, cameras, tablets or laptops, in electric or hybrid vehicles, or for the storage of renewable energy.

### BRIEF DESCRIPTION OF THE DRAWINGS

FIG. 1 presents transmission electron microscopy (TEM) images of the MnCO₃ nanocubes as described in Example 1(a) at (A) low magnification and (B) high magnification.

FIG. 2 displays the characterization of MnCO₃/TiO₂ core-shell nanocubes as described in Example 1(b) by: (A) TEM image; (B, C) high resolution TEM (HRTEM) images; (D) high-angle annular dark-field scanning transmission electron microscopy (HAADF-STEM) image; (E) Ti and Mn map of the nanocube boxed in (D); (F) Ti map of the nanocube boxed in (D); (G) Mn map of the nanocube boxed in (D); and (H) O map of the nanocube boxed in (D).

FIG. 3 presents the characterization of the nanocomposites: (A) powder XRD pattern of MnCO₃/TiO₂, MnO/TiO₂, MnO/TiO₂/RGO, MnO/TiO₂—S, MnO/TiO₂/RGO-S and MnO/TiO₂/RGO-acid-S (each indicated); (B) N2 adsorption/desorption isotherms of MnO/TiO₂, MnO/TiO₂/RGO and MnO/TiO₂/RGO-acid; and (C) thermogravimetric analysis (TGA) curves of MnO/TiO₂—S and MnO/TiO₂/RGO-S.

FIG. 4 displays the characterization of the MnO/TiO₂ core-shell nanocubes as described in Example 1(c) by: (A) TEM image; (B) HRTEM image; (C) HAADF-STEM image; (D) Ti and Mn map of the nanocube boxed in (C); (E) Ti map of the nanocube boxed in (C); (F) Mn map of the nanocube boxed in (C); and (G) O map of the nanocubes boxed in (C).

FIG. 5 shows the linear energy-dispersive X-ray (EDX) profile of MnO/TiO₂/RGO as described in Example 2.

FIG. 6 presents the characterization of the MnO/TiO₂/RGO nanocomposites as described in Example 2 by: (A) TEM image; (B, C) HRTEM images; (D) HAADF-STEM image; (E) C map of the nanocube boxed in (D); (F) Ti map of the nanocube boxed in (D); and (G) Mn map of the nanocube boxed in (D).

FIG. 7 displays the characterization of the MnO/TiO₂/RGO-S nanocomposite material as described in Example 3 by: (A) TEM image; (B) HRTEM image; (C) HAADF-STEM images; (D) Ti map of the nanocomposite in (C); (E) Mn map of the nanocomposite in (C); (F) S map of the nanocomposite in (C); and (G) O map of the nanocomposite material in (C).

FIG. 8 shows the characterization of the MnO/TiO₂—S nanocomposite material as described in Example 3 by: (A) TEM image; (B) HRTEM image; (C) HAADF-STEM images; (D) Ti and Mn map of the nanocomposite in (C); (E) Ti map of the nanocomposite in (C); (F) Mn map of the nanocomposite in (C); and (G) O map of the nanocomposite material in (C).

FIG. 9 displays the EDX profile of MnO/TiO₂/RGO-acid as described in Example 4.

FIG. 10 presents the characterization of MnO/TiO₂/RGO-acid nanocomposites as described in Example 4 by: (A) low magnification TEM image; (B) high magnification TEM image; (C) HAADF-STEM image; (D) Ti map of nanocomposite in (C); (E) Mn map of nanocomposite in (C); and (F) O map of the nanocomposite material in (C).

FIG. 11 displays the characterization of the MnO/TiO₂/RGO-acid-S nanocomposite material as described in Example 4 by: (A) TEM image; (B) HRTEM image; (C) HAADF-STEM image; (D) Ti map of nanocomposite in (C); (E) Mn map of nanocomposite in (C); (F) S map of nanocomposite in (C); and (G) O map of the nanocomposite material in (C).

FIG. 12 demonstrates the electrochemical properties of nanocomposite materials and sulfur nanocrystals as cathode materials for Li—S battery: (A) CV profiles of MnO/TiO₂/RGO-acid-S recorded at a scan rate of 0.05 mV/S; (B) and (C) respectively initial charging and discharging curves at a 0.1 C rate and cycling performance recorded at a 0.2 C rate of MnO/TiO₂/RGO-acid-S, MnO/TiO₂/RGO-S, MnO/TiO₂—S nanocomposite material and sulfur nanocrystals at room temperature; and (D) electrochemical impedance curves of MnO/TiO₂/RGO-acid-S, MnO/TiO₂/RGO-S and MnO/TiO₂—S nanocomposites.

FIG. 13 displays the CV profiles of MnO/TiO₂/RGO-S and MnO/TiO₂—S recorded at a scan rate of 0.05 mVs⁻¹ over a potential range of 1.5 to 2.8 (V vs. Li/Li⁺).

### DETAILED DESCRIPTION

The following detailed description and examples are illustrative and should not be interpreted as further limiting the scope of the invention.

All technical and scientific terms and expressions used herein have the same definitions as those commonly understood by the person skilled in the art relating to the present technology. The definition of some terms and expressions provided below take precedence over their common meaning given in the literature.

The expressions “nanocomposite material” and “nanocomposite” used herein refer to a material made from at least two constituent materials with significantly different physical or chemical properties that, when combined, produce a material with characteristics different from the individual components.

The term “nano” as used herein refers to an object having a nanoscale size (e.g., not more than 100 or not more than 500 nm) at least in one direction.

Unless mentioned otherwise, all ratios mentioned in the present application are weight ratios.

When an interval of values is mentioned in the present application, the lower and upper limits of the interval are, unless otherwise indicated, always included in the definition.

The term “approximately” or the equivalent term “about” as used herein means approximately in the region of, and around. When the term “approximately” or “about” is used in relation to a numerical value, it modifies it, for example, above and below by a variation of 10% in relation to the nominal value. This term may also take into account, for example, the experimental error of a measuring apparatus or rounding.

This application relates to core-shell nanoparticles (NPs) for use in the manufacture of electrochemical cells, particularly in lithium-sulfur (Li—S) electrochemical cells; and their methods of synthesis.

The present application thus proposes core-shell NPs which may be used in composite electrodes to improve the cyclability and to prevent electrochemical cells degradation.

The present application, for example relates to core-shell NPs comprising a porous nanocrystalline metal oxide (of formula M_{y}Oₓ) core which incorporates elemental sulfur (S₈) as an electrochemically active material and an amorphous TiO₂ outer shell. For example, core-shell NPs exhibit cubic or cubic-like morphology (e.g. rhombohedral). In one embodiment, the core-shell NPs may be deposited on a conductive nanomaterial, for instance, reduced graphene oxide (RGO) to form RGO-supported M_{y}Oₓ/TiO₂ core-shell (M_{y}Oₓ/TiO₂/RGO-S) nanocomposites which can be used in cathode materials of electrochemical cells with advantageous capabilities.

The uniqueness of these materials lies at least in (i) the amorphous TiO₂ shell, which absorbs the volume expansion upon lithiation, and alleviates the Li₂Sₓ dissolution, and (ii) the porous nanocrystalline M_{y}Oₓ core, e.g. mesoporous, which provides strong chemical interactions with the lithium Li₂Sₓ ions. The M_{y}Oₓ/TiO₂/RGO-S nanocomposites with different M:Ti molar ratios demonstrated good capacity, coulombic efficiency and cycling stability.

The present application, for example also relates to the synthesis of core-shell NPs defined herein via a wet chemical method. For instance, the process includes the preparation of monodispersed M_{y}(CO₃)ₓ nanoparticles, for example, via a microemulsion-mediated solvothermal synthesis. These M_{y}(CO₃)ₓ nanoparticles are then coated with a thin amorphous TiO₂ layer using a wet chemical step by reacting the nanoparticles with a titanium oxide precursor, such as an organotitanium compound, in the presence of water. The M_{y}(CO₃)ₓ/TiO₂ nanoparticles are then thermally treated, e.g. annealed, to afford M_{y}Oₓ/TiO₂ core-shell nanoparticles. Without wishing to be bound by theory, one could believe that the elimination of CO₂ during this last process step would contribute to the formation of a porous, e.g. mesoporous, core structure. The present description therefore also further relates to M_{y}Oₓ/TiO₂ core-shell nanoparticles, wherein the core M_{y}Oₓ is porous (or mesoporous) and crystalline and the shell comprises TiO₂ in amorphous form.

In another example, these core-shell NPs are used as intermediate to encapsulate elemental sulfur (S₈), the S₈ being incorporated in the core-shell NPs using a melt diffusion method. The synthesis of nanoparticles with several M:Ti molar ratio is also demonstrated in the present application as well as its effect on the performance of electrochemical cells.

The core-shell NPs as described herein have a porous core which allows for the incorporation of elemental sulfur (S₈). NPs can exhibit improved sulfur absorption capabilities which is highly dependent upon porosity and pore size distribution. In one embodiment, the number and/or size of pores can be increased by the partial removal of M through acidic treatment, thereby reducing the M:Ti molar ratio and leading to improved sulfur absorption capabilities. The NPs can also be annealed with conductive nanomaterials beforehand and the elemental sulfur may then be diffused therein as well. The resulting nanocomposite materials can be used as high-capacity cathode materials for lithium sulfur batteries.

The porous M_{y}Oₓ core reduces or prevents leakage of soluble polysulfide ions during battery operation from the core-shell NPs by adsorbing them in the M_{y}Oₓ core. The NPs also show a tolerance for volume expansion under operation conditions of the lithium batteries.

The present application proposes core-shell nanoparticles comprising
a porous metal oxide core of formula M_{y}Oₓ;
elemental sulfur (S₈) as an electrochemically active material, the elemental sulfur being incorporated into the pores of the porous metal oxide core; and
an outer shell surrounding the core, the outer shell comprising TiO₂.

M defines at least one transition metal, y is an integer selected from 1 to 4 and x is an integer selected from 1 to 8, x and y being selected to achieve electroneutrality.

In one example, M is Mn, Fe, Co, Ni, Zn, or a combination thereof; y is an integer selected from 1 to 3; and x is an integer selected within the range of from 1 to 7.

Non-limiting examples of metal oxide cores of formula M_{y}Oₓ include manganese(II) oxide (MnO), manganese oxide (Mn₂O₄), manganese(II,III) oxide (Mn₃O₄), manganese(III) oxide (Mn₂O₃), manganese dioxide (MnO₂), manganese(VI) oxide (MnO₃), manganese(VII) oxide (Mn₂O₇), iron(II) oxide (FeO), iron(III) oxide (Fe₂O₃), iron(II,III) oxide (Fe₃O₄), cobalt(II) oxide (CoO), cobalt(III) oxide (Co₂O₃), cobalt(II,III) oxide (Co₃O₄), nickel(II) oxide (NiO), nickel(III) oxide (Ni₂O₃) and the like. For example, M is Mn, e.g. M_{y}Oₓ is MnO.

In one embodiment, the TiO₂ shell is in amorphous form, the metal oxide comprised in the core is in a crystalline form and the NPs have a cube-like morphology. In another example, the elemental sulfur comprises sulfur nanocrystals.

For example, the core-shell NPs as defined herein, have a M:Ti molar ratio of about 10:1 to about 0.5:1, preferably about 4:1 to about 0.7:1, preferably about 3:1 to about 0.7:1 and most preferably about 2:1 to about 0.8:1.

In another example, the core-shell NPs as defined herein, have an average size in the range of from about 10 to about 500 nm, preferably from about 75 to about 200 nm and an average shell thickness in the range of from about 1 to about 50 nm, preferably from about 5 to about 20 nm. The metal oxide core of the present nanoparticles has a porous morphology, for instance, a mesoporous morphology (i.e. pores having an average size below 50 nm). The specific surface area of the core-shell NPs before sulfur insertion, as measured by Brunauer-Emmett-Teller (B.E.T.), is between about 20 and about 150 m²/g, or between about 30 and about 100 m²/g, or between about 30 and about 60 m²/g.

In another embodiment, a nanocomposite material is also contemplated, where the nanocomposite material comprises the core-shell NPs as described herein together with a first conductive agent. For instance, the nanocomposite material comprising the core-shell NPs as defined herein, wherein the nanoparticles are thermally treated with, e.g. annealed to, the first conductive nanomaterial. For instance, the NPs are supported on the first conductive material. Such nanocomposites have been shown to provide high capacity and cycling stability in electrochemical cells.

In one embodiment, the first conductive nanomaterial is a conductive nanocarbon nano-wire, nano-sheet, nano-belt, or a combination thereof. The first conductive nanomaterial is selected for its ability to improve the electrical conductivity of the NPs. For example, the first conductive nanomaterial is a reduced graphene oxide (RGO) nanosheet or a graphene nanosheet having a lateral size of about 50 to about 500 nm, preferably of about 100 to about 200 nm wherein the first conductive nanomaterial to NPs (excluding sulfur) weight ratio is about 1:1 to about 1:10, preferably about 1:2 to about 1:4. In another embodiment, the nanocomposite material has specific surface area measured by Brunauer-Emmett-Teller (B.E.T.) of about 50 m²/g to about 150 m²/g, or about 50 m²/g to about 100 m²/g, preferably about 80 to about 100 m²/g, before addition of sulfur to the material. In another embodiment, the weight ratio of sulfur to the nanocomposite material before sulfur insertion is about 10:1 to about 1:2, preferably about 3:1 to about 1:1.

The core-shell NPs may be made through different methods. One method for the preparation of the present core-shell nanoparticles includes the steps of preparing core-shell M_{y}Oₓ/TiO₂ nanoparticles, wherein the M_{y}Oₓ core is porous (e.g. mesoporous) and the TiO₂ shell in amorphous; mixing the M_{y}Oₓ/TiO₂ nanoparticles with elemental sulfur; and heating at a temperature allowing the sulfur to melt and diffuse into the pores of the core. One method for preparing core-shell nanoparticles or nanocomposite materials as herein defined involves:

(a) contacting M_{y}(CO₃)ₓ nanoparticles with TiO₂ or a TiO₂ precursor to form TiO₂ coated M_{y}(CO₃)ₓ nanoparticles (i.e. M_{y}(CO₃)ₓ/TiO₂);

(b) thermally treating (e.g. annealing) the M_{y}(CO₃)ₓ/TiO₂ nanoparticles from step (a) at elevated temperature under inert gas to form core-shell M_{y}Oₓ/TiO₂ nanoparticles;

(c) optionally thermally treating (e.g. annealing) the core-shell nanoparticles with a first conductive nanomaterial under inert gas at elevated temperature, optionally in the presence of hydrogen gas, to form a nanocomposite material;

(d) optionally partly removing M_{y}Oₓ after step (b) or (c) by treatment with an acid;

(e) milling the obtained nanoparticles or nanocomposite material with elemental sulfur (S₈) to produce a mixture; and

(f) heating the obtained mixture obtained in step (e) at elevated temperature under inert gas to cause the sulfur to melt-diffuse into the pores of the nanoparticles and/or nanocomposite material.

The above process may further include step (c) or step (d) or both of steps (c) and (d) in any order. When step (c) is present, then the product obtained is a nanocomposite material.

For example, the acid of step (d) is a mineral acid, preferably H₂SO₄ or HCl, preferably used in a concentration of 0.1 to 5 M. In another example, the thermal treatment steps (b) and (c) when present, are performed each independently at a temperature of about 200 to about 500° C., preferably about 300 to about 400° C. and the heating step (f) is performed at a temperature of about 140 to about 180° C. for about 5 to about 48 hours.

Another method for producing the nanoparticles or nanocomposite material herein described, e.g. MnO/TiO₂—S, MnO/TiO₂-acid-S, MnO/TiO₂/RGO-S, or MnO/TiO₂/RGO-acid-S, involves:

(a) synthesizing of MnCO₃ nanoparticles by a microemulsion-mediated solvothermal reaction;

(b) reacting the MnCO₃ nanoparticles from step (a) in a polar solvent with a TiO₂ precursor, preferably an organotitanium compound, to produce MnCO₃/TiO₂ nanoparticles;

(c) thermally treating (e.g. annealing) the MnCO₃/TiO₂ nanoparticles at elevated temperature under inert gas to produce core-shell MnO/TiO₂ nanoparticles;

(d) optionally thermally treating (e.g. annealing) the MnO/TiO₂ core-shell nanoparticles with a first conductive nanomaterial under inert gas at elevated temperature, optionally in the presence of hydrogen gas, to form a nanocomposite material;

(e) optionally partly removing MnO after step (c) or (d) by treatment with an acid;

(f) milling the nanoparticles or nanocomposite obtained in step (c), (d) or (e) with elemental sulfur to produce a mixture; and

(g) heating the mixture obtained in step (f) at elevated temperature under inert gas to cause the sulfur to melt-diffuse into the nanocomposite.

The above process may further include step (d) or step (e) or both of steps (d) and (e) in any order. When step (d) is present, then the product obtained is a nanocomposite material.

For example, the acid of step (e) is a mineral acid, preferably H₂SO₄ or HCl, preferably used in a concentration of 0.1 to 5 M. In another example, the thermal treatment steps (c) and (d) when present are performed each independently at a temperature of about 200 to about 500° C., preferably about 300 to about 400° C. and the heating step (f) is performed at a temperature of about 140 to about 180° C. for about 5 to about 48 hours.

Non-limiting examples of titanium oxide precursors include one or more organotitanium compounds selected from titanium tetraisopropoxide, titanium tetra-n-butoxide, titanium tetrakis(2-ethylhexyloxide), titanium tetrastearyloxide, titanium acetylacetonate, titanium ethyl acetoacetate, salicylaldehyde ethyleneimine titanate, diacetone alkoxy titanium, octylene glycoxy titanium, triethanolamine titanate, titanium lactate, monocyclopentadienyltitanium trihalides, dicyclopentadienyltitanium dihalides, cyclopentadienyltitanium trimethoxide, cyclopentadienyltitanium triethoxide and cyclopentadienyltitanium tripropoxide. For example, the organotitanium compound is titanium tetra-n-butoxide (Ti(IV) butoxide).

Electrochemical cells and batteries comprising the nanocomposite as defined herein are also contemplated. For example, at least one element of the electrochemical cells comprises the nanocomposite as defined herein. Such element may be an electrode material, and more preferably the positive electrode material. The electrode material may further comprise a second conductive material, a binder and/or optional additives. For example, the electrode material may be mixed as a slurry with the second conductive material, the binder, a solvent and optionally one or more additives.

Non-limiting examples of the second conductive material may include a carbon source such as carbon black, carbon Ketjen™, acetylene black, graphite, graphene, carbon fibers (such as carbon nanofibers or VGCF formed in the gas phase), and carbon nanotubes, or a combination of at least two of these. For example, the second conductive material is a combination of Ketjen™ black carbon (e.g. ECP600JD) and vapor grown carbon fibers (VGCF).

Non-limiting examples of binders include a linear, branched and/or crosslinked polymeric binder of the polyether type and may be based on poly(ethylene oxide) (PEO), poly(propylene oxide) (PPO) or a mixture of the two (or an EO/PO copolymer), which optionally comprises crosslinkable units; a fluorinated polymer such as polyvinylidene fluoride (PVDF) or polytetrafluoroethylene (PTFE); or a water-soluble binder such as SBR (styrene-butadiene rubber), NBR (acrylonitrile-butadiene rubber), HNBR (hydrogenated NBR), CHR (epichlorohydrin rubber) acrylate), optionally comprising CMC (carboxymethylcellulose). For example, the binder is PVDF.

According to one example, the positive electrode material can be applied to a current collector (e.g., aluminum, copper) to form the positive electrode. Alternatively, the positive electrode can be self-supporting. For example, the current collector is aluminum.

The present application also proposes an electrochemical cell comprising the positive electrode as defined herein, a negative electrode and an electrolyte.

For more certainty, the electrochemically active material of the negative electrode may be selected from any known material compatible with the use of the present positive electrode material, such as alkali metal films, e.g. metallic lithium film or an alloy thereof. For example, the negative electrode is a metallic lithium film.

The electrolyte is selected for its compatibility with the various elements of the electrochemical cell. Any type of electrolyte is contemplated including, for example, liquid, gel or solid electrolytes.

Compatible electrolytes generally comprise at least one lithium salt such as lithium hexafluorophosphate (LiPF₆), lithium bis(trifluoromethanesulfonyl)imide (LiTFSI), lithium bis(fluorosulfonyl)imide (LiFSI), 2-trifluoromethyl-4-dicyanoimidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCl), lithium bromide (LiBr), lithium fluoride (LiF), and compositions comprising them dissolved in a non-aqueous (organic) solvent or a solvating polymer.

Compatible liquid electrolytes may further include a polar aprotic solvent such as ethylene carbonate (EC), diethyl carbonate (DEC), propylene carbonate (PC), dimethyl carbonate (DMC), ethyl methyl carbonate (EMC), γ-butyrolactone (γ-BL), vinyl carbonate (VC), dimethoxyethane (DME), 1,3-dioxolane (DOL) and mixtures thereof, and lithium salts as defined above. Other examples of compatible liquid electrolytes include molten salt (ionic liquid) electrolytes. Non-limiting examples of liquid electrolytes of molten salts include lithium salts such as LiCl, LiBr, LiF, and compositions comprising them, or organic salts. Non-limiting examples of molten salts liquid electrolytes can be found in US20020110739 A1. The liquid electrolyte may impregnate a separator such as a polymer separator (e.g., polypropylene, polyethylene, or a copolymer thereof). For example, the electrolyte is lithium bis(trifluoromethane)sulfonamide and lithium nitrate (2%) in a solvent mixture of 1,3-dioxolane and 1,2-dimethoxy ethane (1:1 v/v) impregnating a polyethylene-based separator.

Compatible gel electrolytes may include, for example, polymer precursors and lithium salts (such as LiTFSI, LiPF₆, etc.), an aprotic polar solvent as defined above, a polymerization and/or crosslinking initiator when required. Examples of such gel electrolytes include, without limitation, the gel electrolytes disclosed in the PCT applications published under WO2009/111860 (Zaghib et al.) and WO2004/068610 (Zaghib et al.). A gel electrolyte may also impregnate a separator as defined above.

Solid polymer electrolytes can generally comprise a crosslinked or non-crosslinked polar solvating solid polymer or polymers and salts, for example, lithium salts such as LiTFSI, LiPF₆, LiDCTA, LiBETI, LiFSI, LiBF₄, LiBOB, etc. Polyether polymers such as polymers based on poly(ethylene oxide) (PEO) may be used, but several other lithium compatible polymers are also known to produce solid polymer electrolytes. Examples of such polymers include star-shaped or comb-like multi-branched polymers such as those disclosed in PCT application no. WO2003/063287 (Zaghib et al.).

According to another aspect, an electrochemical cell of the present application is included in a lithium battery. For example, the lithium battery is a lithium-sulfur battery.

The present application also proposes an electrochemical cell of the present application included in a high performance all-solid-state lithium-sulfur battery. For example, the electrochemical cell comprises the positive electrode as defined herein, a negative electrode and a solid polymer electrolyte.

According to another aspect, the electrochemical cells of the present application are used in mobile devices, for example mobile phones, cameras, tablets or laptops, in electric or hybrid vehicles, or for the storage of renewable energy.

### EXAMPLES

The following non-limiting examples are illustrative embodiments and should not be construed as further limiting the scope of the present invention. These examples will be better understood with reference to the accompanying figures.

The nanoparticles, nanocubes and nanocomposite materials described in the following example were characterized by TEM, HRTEM and HAADF-STEM (FEI Tecnai G² F20 electron microscope). Samples for TEM studies were prepared by putting a droplet of the NPs solution on a copper grid coated with a thin carbon film, followed by evaporation in air at room temperature. The catalyst composition was determined in situ by an EDX attachment (Oxford Instruments X-Max 80TLE) to the microscope. XRD patterns were recorded on a Rigaku D/Max-3B diffractometer using Cu K_{α} radiation (A=1.54056 Å). B.E.T. surface areas of the samples were calculated from nitrogen sorption at 77 K on a Micromeritics ASAP 2020 instrument. The TGA experiment was performed under flowing nitrogen on a TA Instruments Discovery TGA 55 (heating rate=5° C./min).

### Example 1—Synthesis of Core-Shell MnO/TiO₂ NPs

(a) Synthesis of Monodispersed MnCO₃ Precursor Nanoparticles

In one example, the core-shell MnO/TiO₂ NPs are MnO/TiO₂ NPs. The MnO/TiO₂ NPs uses monodispersed MnCO₃ NPs as a synthesis precursor. In the first step of the synthesis, monodispersed MnCO₃ NPs were prepared as a self-template via a cationic surfactant-CTAB-microemulsion-mediated solvothermal method. To perform this synthesis, 2.0 g of cetyltrimethylammonium bromide (CTAB), 10 mmol of manganese(II) chloride tetrahydrate (MnCl₂.4H₂O), 2.0 mL of water, 3.0 mL of 1-butanol and 60 mL of cyclohexane were added to a first container and mixed to form a first miroemulsion. 8.0 g of CTAB, 19 mmol of potassium bicarbonate (KHCO₃), 1.0 mmol of ammonium bicarbonate (NH₄HCO₃), 2.0 mL of water, 3.0 mL of 1-butanol and 240 mL of cyclohexane were added to a second container and mixed to form a second microemulsion. Both water-in-oil microemulsions were obtained after magnetic stirring at room temperature for 1 hour. The feedstock from the first container was then introduced in the second container under continuous stirring. The resulting microemulsion was then stirred for 30 minutes.

A size-selective separation process was then performed on the resulting microemulsion to obtain highly monodispersed manganese (II) carbonate (MnCO₃) nanocubes. To do so, the resulting microemulsion was centrifuged at 8000 rpm for 5 minutes, the supernatant was removed, and the precipitate was dispersed in ethanol by ultrasonication to form a uniform suspension. The suspension was then centrifuged at 3000 rpm for 2 minutes; after these 2 minutes the milky supernatant suspension was saved, while the precipitate was discarded. The suspension was then centrifuged at 8000 rpm for 5 minutes and the precipitate was collected and re-dispersed in ethanol by ultrasonication to form a uniform MnCO₃ nanocubes suspension. The concentration of the MnCO₃ nanocubes suspension was determined by weighting dried MnCO₃ nanocubes from a fixed volume of said MnCO₃ nanocubes suspension and was determined to be about 0.1 M. The MnCO₃ precursor NPs were obtained by drying the MnCO₃ nanocubes suspension in an oven at 80° C.

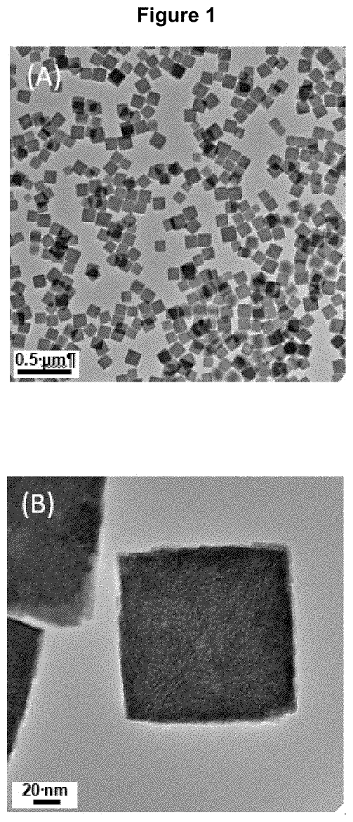

The MnCO₃ precursor NPs were then characterized using low and high magnification transmission electron microscopy (TEM) images. As can be appreciated from FIG. 1 (A and B), the sample has a highly monodispersed cube-like morphology with a particle size of about 125 nm.

(b) Preparation of the MnCO₃/TiO₂ Core-Shell Nanoparticles

The synthesis of the MnCO₃/TiO₂ core-shell nanomaterials was performed by dispersing 8 mL of the MnCO₃ NPs from (a) at a concentration of 0.2 M in ethanol in 125 mL of acetonitrile, 375 mL of ethanol and 5.4 mL of deionized water. The solution was stirred vigorously for 30 minutes. Then, 1 mL of Ti(IV) tetra-n-butoxide (form Sigma-Aldrich) was added to the dispersion. The dispersion was allowed to react for 20 hours. The MnCO₃/TiO₂ core-shell NPs were collected by centrifugation, washed with ethanol and then dried.

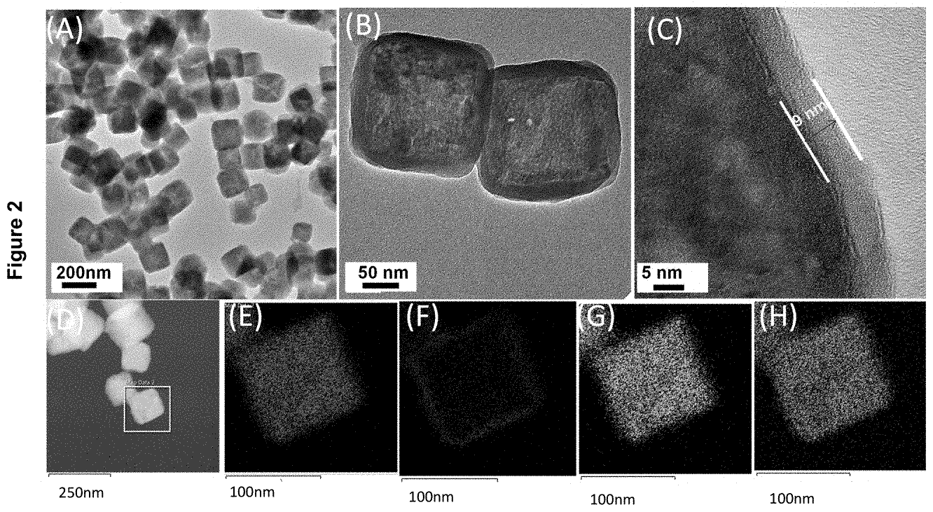

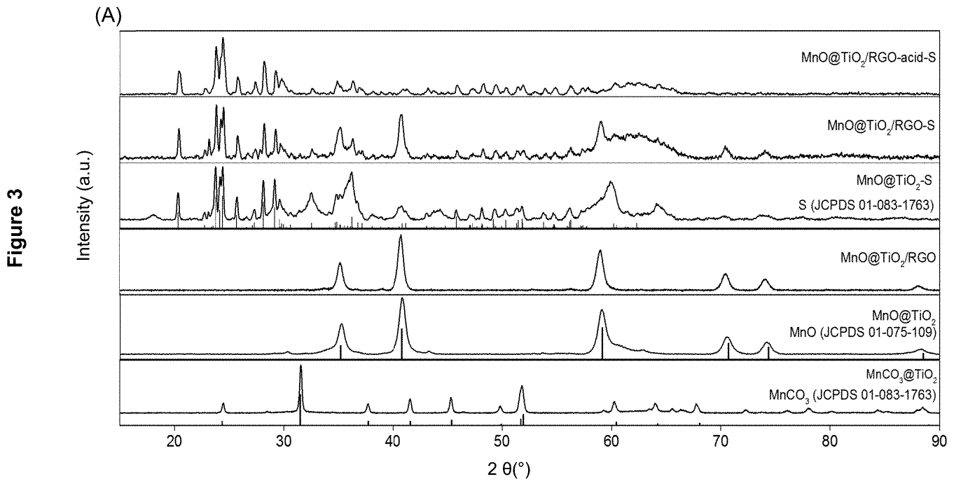

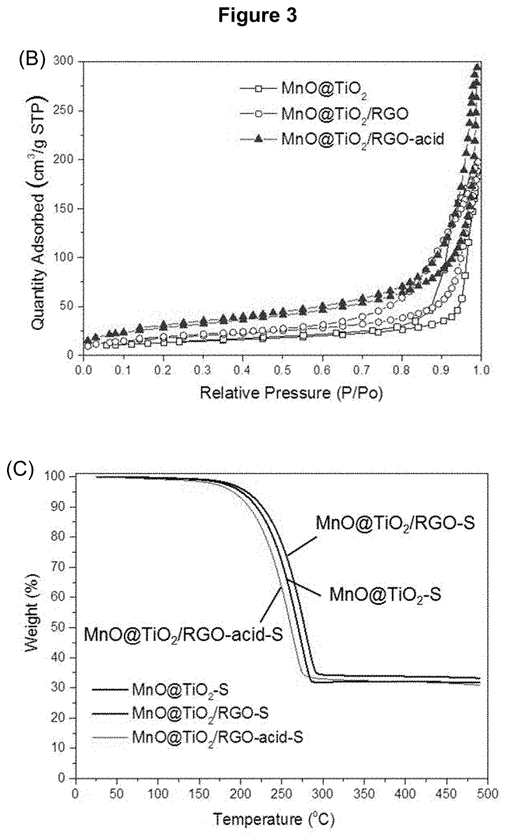

The morphology of the MnCO₃/TiO₂ core-shell NPs was then characterized by TEM. As can be seen in FIG. 2 (A), the TEM images showed that the resulting material is highly monodispersed with a cube-like morphology. FIGS. 2 (B) and (C) are high resolution TEM (HRTEM) images and illustrate the core shell structure, where the core was shown to be porous and the shell had a thickness of about 9.5 nm. The formation of core-shell structure was confirmed by the elemental maps in FIGS. 2 (D) to (H) of these NPs in the high-angle annular dark-field scanning transmission electron microscopy (HAADF-STEM) image. Powder X-ray diffraction (XRD) was then performed and the pattern in FIG. 3 (A) indicated only crystalline peaks for rhombohedral MnCO₃ (JCPDS card No. 44-1472) and the TiO₂ phase was found to be amorphous.

(c) Preparation of the MnO/TiO₂ Nanoparticles

This example illustrates the process for producing MnO/TiO₂ NPs. The MnO/TiO₂ NPs were obtained by annealing at a temperature of about 350° C. the MnCO₃/TiO₂ core-shell NPs as described in Example 1 (b) under an argon atmosphere for 4 hours.

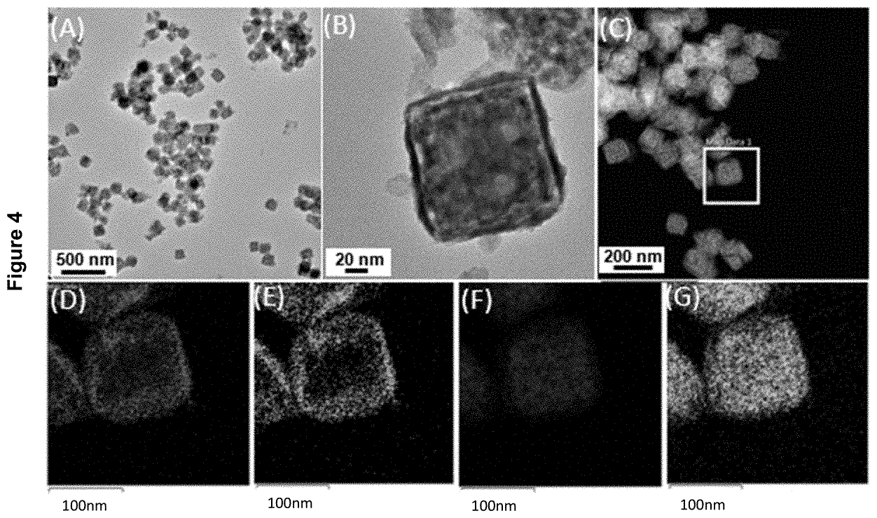

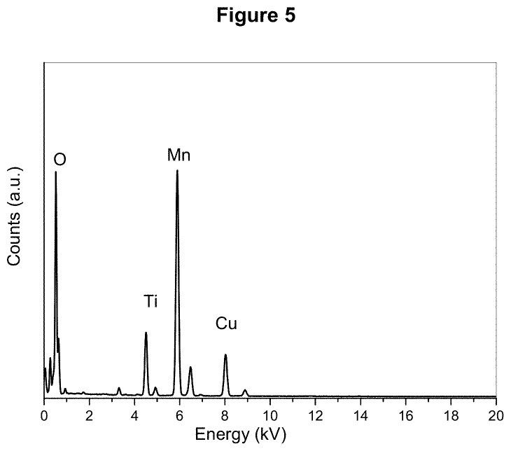

The MnO/TiO₂ NPs were then characterized. The core-shell structure could be easily observed in FIG. 4 from the contrast between Mn and Ti in TEM and HAADF-STEM images. The shell thickness was about 9.8 nm. The core-shell structure was confirmed by the elemental maps of these NPs in HAADF-STEM image. In FIG. 5, the linear energy-dispersive X-ray (EDX) profile of an individual core-shell nanoparticle confirmed a Ti:Mn molar ratio of 1:4. The XRD pattern (FIG. 3 (A)) of the material was similar to that of MnO nanocubes (JCPDS 01-075-109) and no crystalline TiO₂ phase was detected. The nitrogen adsorption-desorption isotherms of the as-prepared MnO/TiO₂ NPs (FIG. 3 (B)) showed a type IV hysteresis loop, which is characteristic of a mesoporous material. The Brunauer-Emmett-Teller (B.E.T.) surface area was 46.8 m²/g. The porous core structure could be generated by the release of CO₂ gas during the decomposition of MnCO₃ upon calcination.

### Example 2—Production of Nanocomposite Material Comprising a Conductive Nanomaterial

This example illustrates the addition of a conductive nanomaterial to MnO/TiO₂ NPs in order to increase its electronic conductivity. To do so, a uniform graphene oxide suspension was prepared by ultrasonically dispersing 100 mg of graphene oxide (GO) in 100 mL of deionized water with 100 mg of CTAB. 400 mg of as-prepared MnO/TiO₂ NPs from Example 1 were then added to the GO suspension under magnetic stirring. After thorough mixing, the water was removed by centrifugation, and the sample was dried at room temperature in a vacuum oven overnight. The dried powder was annealed under argon atmosphere containing H₂ (5%) at 350° C. for 4 hours to form the MnO/TiO₂/RGO nanocomposite material.

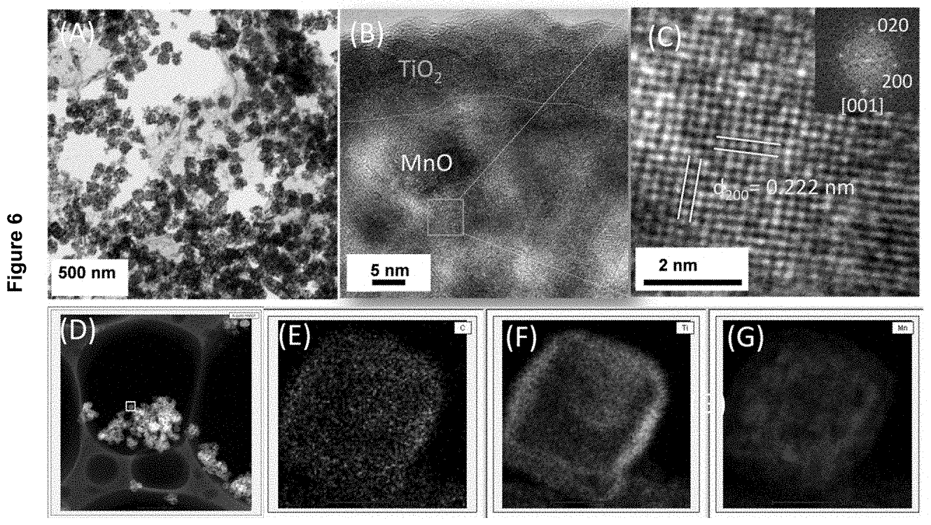

The MnO/TiO₂/RGO nanocomposite material was then characterized. The TEM images suggested that the MnO/TiO₂ NPs were well-dispersed on the RGO nanosheets (FIG. 6). The core-shell structure of MnO/TiO₂ NPs was preserved, as shown by the HAADF-STEM image of these particles. The crystalline nature of the core was confirmed by the high-resolution TEM (HRTEM) image and the corresponding fast Fourier-transform (FFT) pattern (FIG. 6 (C)) of the area selected in FIG. 6 (B). The 0.222 nm d-spacing marked in FIG. 6 (C) corresponded to (200) lattice fringes of the cubic MnO with a unit cell of a=b=c=4.446 Å. No phase change was observed when comparing the XRD patterns of MnO/TiO₂/RGO nanocomposite material and MnO/TiO₂ NPs (see FIG. 3 (A)). The porous nature of the MnO/TiO₂/RGO nanocomposite material was illustrated by N2 adsorption-desorption isotherms (FIG. 3 (B)). The sample has a specific surface area measured by B.E.T. of 60.7 m²/g.

### Example 3—Elemental Sulfur (S₈) Incorporation by Melt-Diffusion

This example illustrates the incorporation of elemental sulfur (S₈) in the MnO/TiO₂ nanoparticles of Example 1 or the MnO/TiO₂/RGO nanocomposite material of Example 2 by melt-diffusion. An amount of 1 g of MnO/TiO₂ NPs and of MnO/TiO₂/RGO nanocomposite were each milled with 2 g of sulfur nanocrystals. The mixtures were each sealed in a polytetrafluoroethylene (PTFE) or Teflon™ container under inert atmosphere in a glove box and heated at 160° C. for 20 hours to incorporate the sulfur into the nanocomposite material by melt-diffusion to obtain MnO/TiO₂—S and MnO/TiO₂/RGO-S nanocomposite materials.

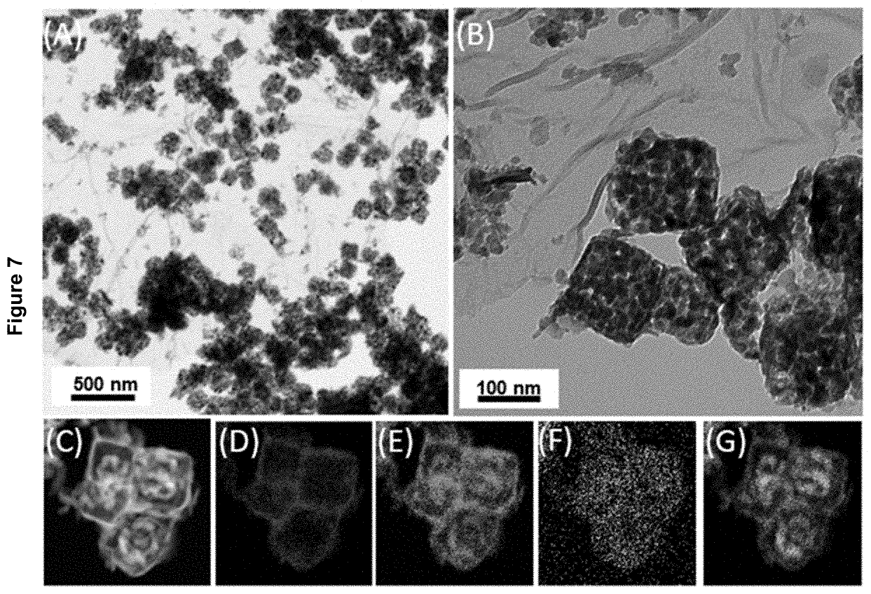

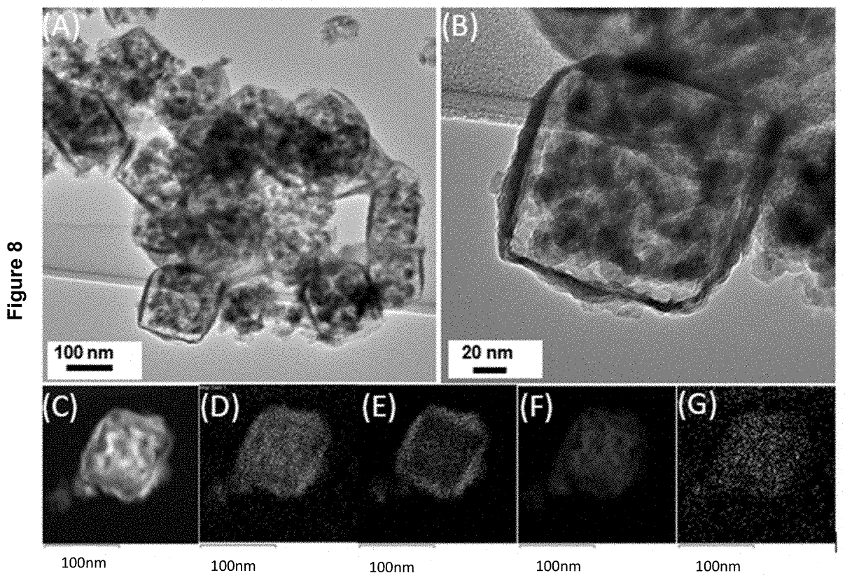

TEM images and elemental maps of HAADF-STEM image (FIG. 7) of the MnO/TiO₂/RGO-S nanocomposite suggested that the MnO/TiO₂—S NPs were well-dispersed on RGO nanosheets and preserved their core-shell structure. The elemental maps of these NPs in HAADF-STEM image also confirmed that the sulfur nanocrystals were trapped in the MnO/TiO₂/RGO nanocomposite materials. The sample had an XRD pattern (FIG. 3 (A)) similar to that of sulfur nanocrystals (JCPDS card No. 01-083-1763). Thermal gravimetric analysis (TGA) indicated a similar loading of sulfur nanocrystals in MnO/TiO₂/RGO-S and MnO/TiO₂—S(about 66.7 wt % and 68.2 wt %, respectively) (FIG. 3 (C)). TEM images, HRTEM images and elemental maps of HAADF-STEM image were also recorded for MnO/TiO₂—S nanocomposites (FIG. 8).

### Example 4—Molar Ratios of MnO and TiO₂

MnO/TiO₂/RGO-S with different molar ratios of MnO to TiO₂ were also synthesized. The MnO/TiO₂/RGO nanocomposite was treated with acid to remove excess MnO (partial removal). To prepare MnO/TiO₂/RGO with different Ti:Mn ratios, the dried powder (500 mg) was dispersed in 100 mL of deionized water, and then treated with 10 mL of H₂SO₄ (1 M) to remove part of the MnO. After 1 hour of reaction, the nanocomposite was collected by centrifugation and dried in a vacuum oven to afford a nanocomposite referred to as MnO/TiO₂/RGO-acid.

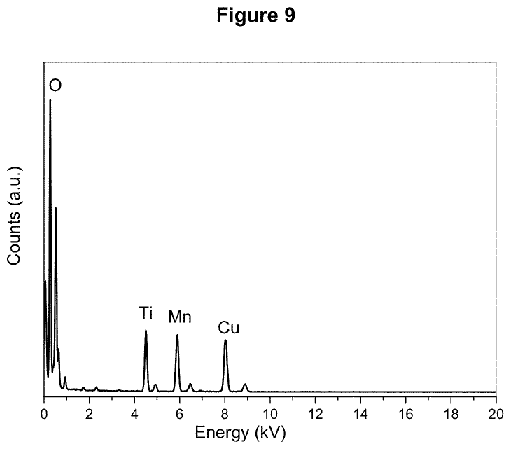

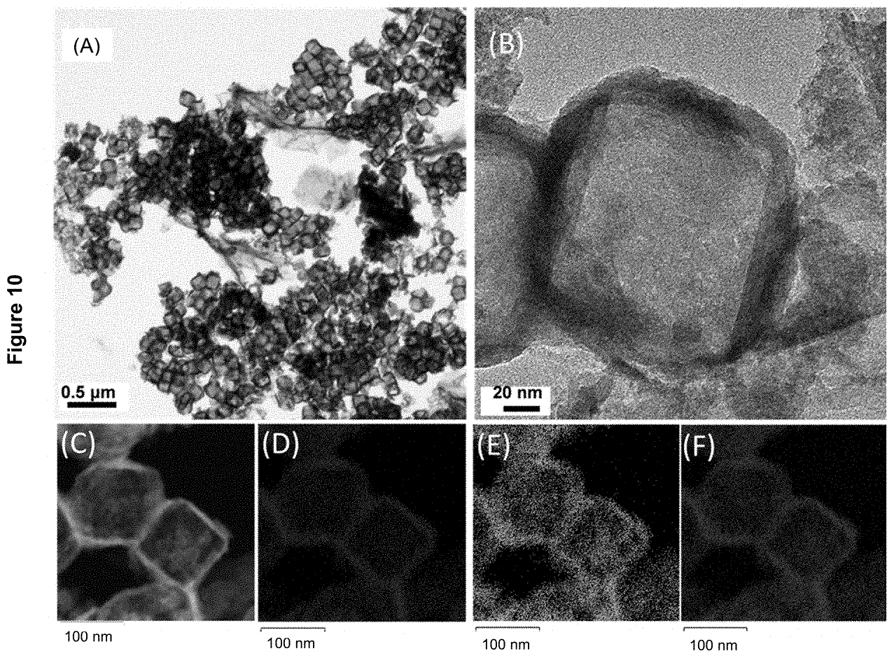

The EDX profile of an individual MnO/TiO₂/RGO-acid core-shell NP confirmed that the Ti:Mn molar ratio was about 1:1 (FIG. 9). As shown by the TEM and the HAADF-STEM images (FIG. 10), MnO/TiO₂ NPs in the MnO/TiO₂/RGO-acid sample preserved the cubic morphology, and the NPs were well-dispersed on the RGO nanosheets. The elemental maps of these particles in HAADF-STEM image also confirmed that the shell was comprised of TiO₂, and the core was comprised of MnO. The MnO/TiO₂/RGO-acid nanocomposite material had a B.E.T. specific surface area of 95.9 m²/g.

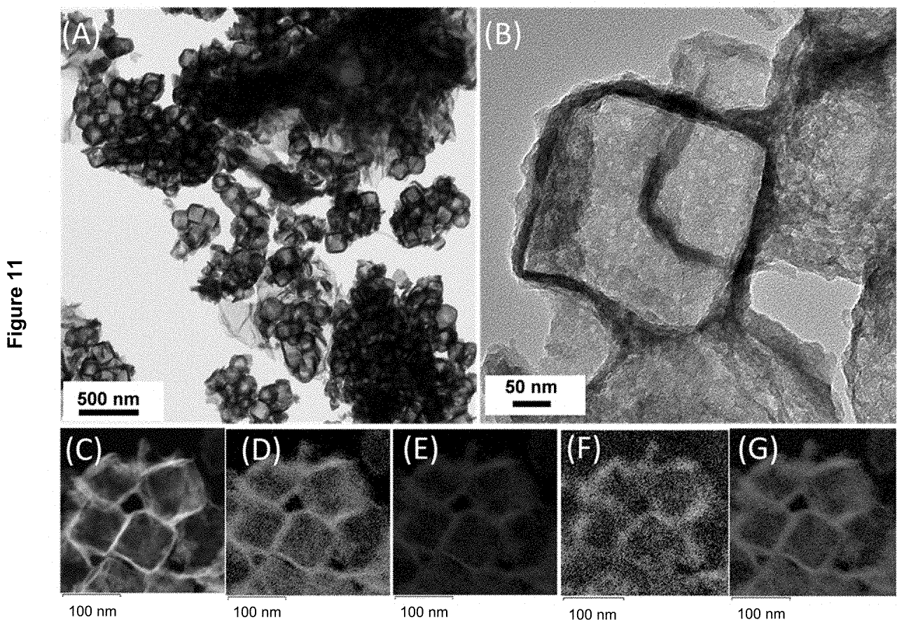

Sulfur nanocrystals were then incorporated by melt diffusion as described in Example 3. The resulting MnO/TiO₂/RGO-acid-S still retained the cubic morphology of MnO/TiO₂, and the NPs were well dispersed on the surface of RGO (FIG. 11). The elemental maps of these particles in HAADF-STEM image also confirmed that the sulfur nanocrystals were trapped in the MnO/TiO₂/RGO-acid nanocomposite material. MnO/TiO₂/RGO-acid-S showed a XRD pattern similar to that of sulfur nanocrystals (FIG. 3 (A)).

### Example 5: Preparation of Cells

(a) Cathodes

Cathode materials comprising nanocomposite materials were prepared in the weight ratios detailed in Table 1. The materials were prepared by mixing the nanocomposite material using a SamplePrep 8000M Mixer/Mill™ high-energy ball miller from Spex™ for 1 hour, Ketjen™ black carbon (ECP600JD), vapor grown carbon fibers (VGCF), and polyvinylidene fluoride (PVDF) in N-methyl-2-pyrrolidone (NMP). The mixture was then rolled into thin sheets with a thickness of about 15 μm, which were then punched and pressed onto round aluminum meshes.

TABLE 1
Cathode material weight concentration

| | Nanocomposite | | | |
|---|---|---|---|---|
| | material | Carbon 1 | Carbon 2 | Binder |
| Cathode | (wt %) | (wt %) | (wt %) | (wt %) |
| C1 | Sulfur nanocrystals | C-Ketjen ™ | C-VGCF | PVDF |
| | (60%) | (15%) | (15%) | (10%) |
| C2 | MnO/TiO₂-S | C-Ketjen ™ | C-VGCF | PVDF |
| | (60%) | (15%) | (15%) | (10%) |
| C3 | MnO/TiO₂/RGO-S | C-Ketjen ™ | C-VGCF | PVDF |
| | (60%) | (15%) | (15%) | (10%) |
| C4 | MnO/TiO₂/RGO- | C- Ketjen ™ | C-VGCF | PVDF |
| | acid-S | (15%) | (15%) | (10%) |
| | (60%) | | | |

(b) Cells

The cells were assembled in standard CR2032 size coin cell casings (i.e. 20 mm diameter and 3.2 mm height), with the cathodes prepared in (a), a metallic lithium disk as the anode, 25 μm polyethylene-based separators impregnated lithium bis(trifluoromethane)sulfonamide and lithium nitrate (2%) in a solvent mixture of 1,3-dioxolane and 1,2-dimethoxy ethane (1:1 v/v) as the electrolyte. All cells were assembled in an argon-filled glove box.

TABLE 2
Cell configurations

| Cell | Cathode |
|---|---|
| Cell 1 | C1 |
| Cell 2 | C2 |
| Cell 3 | C3 |
| Cell 4 | C4 |

### Example 6: Electrochemical Properties

(a) Cyclic Voltammetry

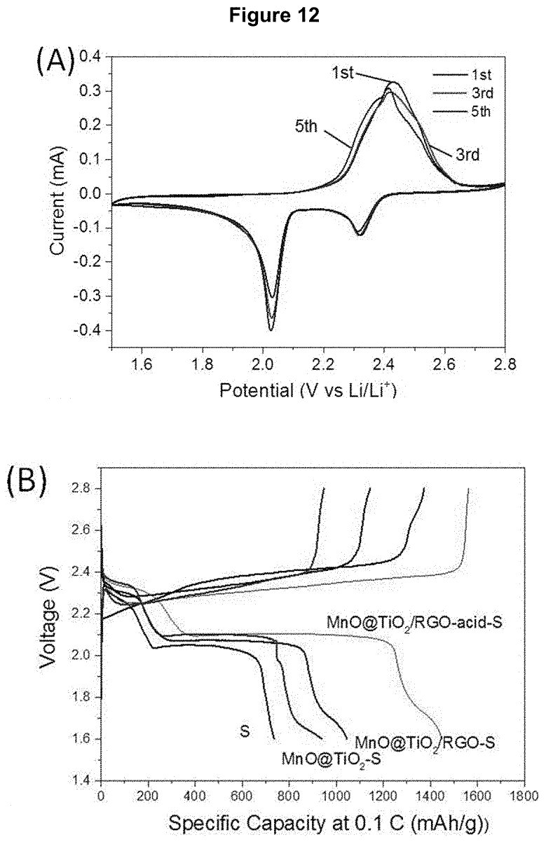

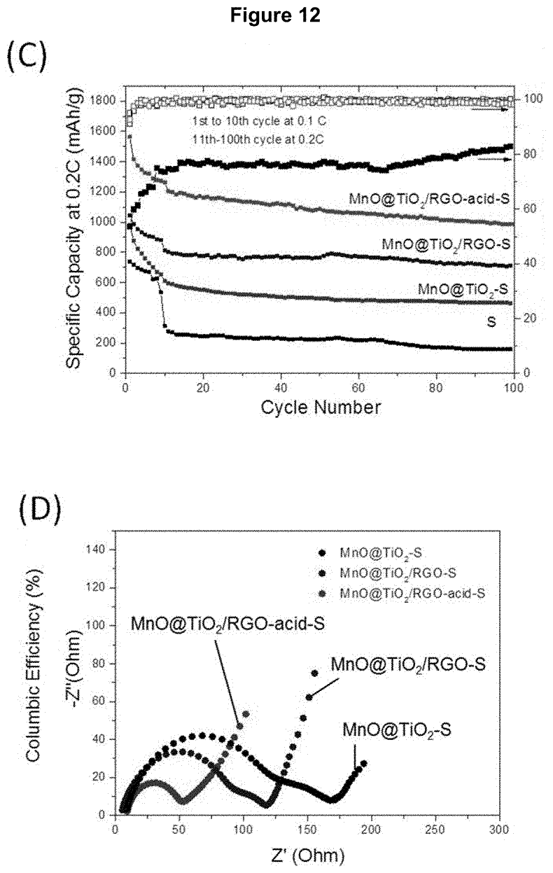

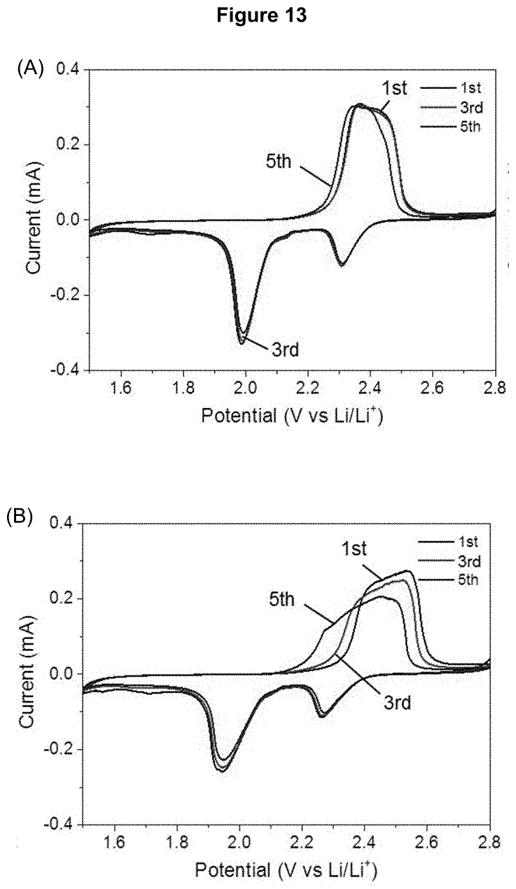

Cyclic voltammograms (CV) were recorded for the Li—S cells prepared in Example 5, i.e. comprising the composite materials described in Examples 3 and 4 as cathode active material. The CV were recorded with the electrochemical workstation (from Autolab) at a scanning rate of 0.05 mVs⁻¹ in the range of 1.5 to 2.8 (V vs Li/Li⁺). As can be observed in FIG. 12 (A) and FIG. 13, the CV displayed two reduction peaks, one at 2.33 V and another at 2.02 V in FIG. 12A, which corresponded to the reduction of elemental (S₈) into a long-chain polysulfide (Li₂Sₓ, 4≤x≤8), and lower polysulfide species Li₂S₂ and Li₂S. A difference in reduction peaks between the first and fifth cycles may be observed and could be attributed to the partial decomposition of electrolyte at the high voltage, and the formation of a solid-electrolyte interface (SEI).

(b) Galvanostatic Charge and Discharge Profile

The galvanostatic charge and discharge profiles were studied to test the performances of cells prepared in Example 5 comprising the composite materials as described herein. The galvanostatic charge/discharge tests were performed using an Arbin Instruments testing system (Arbin BT-2000).

As shown in FIG. 12 (B), a high initial charge capacity of 1562 mAh/g and a discharge capacity of 1451 mAh/g were obtained for Cell 4 comprising the MnO/TiO₂/RGO-acid-S, nanocomposite material, which were higher than those of Cell 3 comprising the MnO/TiO₂/RGO-S nanocomposite material (1145 mAh/g and 1045 mAh/g) and Cell 2 comprising the MnO/TiO₂—S nanocomposite material (948 mAh/g and 938 mAh/g), corresponding to a more active sulfur utilization. Although some capacity loss could not be avoided, reversible discharge capacities of about 986 mAh/g for Cell 4, about 712 mAh/g for Cell 3 and about 463 mAh/g for Cell 2 were retained after 100 cycles at 0.2 C with good coulombic efficiency (>98%), respectively (see FIG. 12 (C)), which was superior to that of the sulfur nanocrystal-containing Cell 1 (about 160 mAh/g and 83%). The superior electrochemical performance of Cell 3 could be attributed to its stable hollow architecture, which could have prevented the swelling problem associated with sulfur and polysulfide formation during the charge and discharge cycles. Furthermore, strong chemical adsorption between polysulfide and MnO could have further enhanced the sulfur stability of the Li—S battery. Cell 4 comprising a low Mn:Ti molar ratio (1:1) displayed better capacity than that with high Mn:Ti molar ratio (4:1). This could be attributed to more a porous MnO core which could have accommodated more sulfur crystal after acid treatment. This was confirmed by the much higher B.E.T. specific surface area for MnO/TiO₂/RGO-acid-S compared to that of MnO/TiO₂/RGO-S nanocomposite materials.

(c) Impedance

Electrochemical impedance spectroscopy (EIS) was performed on the cells comprising the nanocomposites (see FIG. 12 (D)). The depressed semicircle in the high-to-medium frequency region of the Nyquist profiles corresponded to the charge-transfer resistance at the electrode/electrolyte interface: about 52.4Ω for Cell 4, about 119.6Ω for Cell 3, and about 169.8Ω for Cell 2. The low transfer resistance of Cell 4 indicated the high rate capability and stability of this material. EIS were recorded by applying a sine wave with an amplitude of 10 mV over the frequency range of 100 kHz to 10 MHz.

Numerous modifications could be made to any of the embodiments described above without departing from the scope of the present invention. Any references, patents or scientific literature documents referred to in the present document are incorporated herein by reference in their entirety for all purposes.

1. Core-shell nanoparticles comprising
a porous metal oxide core of formula M_{y}Oₓ, wherein M defines at least one transition metal, y is an integer selected from 1 to 4, and x is an integer selected from 1 to 8, x and y being selected to achieve electroneutrality;
elemental sulfur (Ss) as an electrochemically active material, the elemental sulfur being incorporated into the pores of the metal oxide core; and
an outer shell surrounding the core, the outer shell comprising TiO₂.

2. The core-shell nanoparticles of claim 1, wherein M is Mn, Fe, Co, Ni, Zn or a combination thereof; y is an integer from 1 to 3; and x is an integer from 1 to 7.

3. The core-shell nanoparticles of claim 2, wherein M is Mn or wherein MA is MnO.

4. (canceled)

5. The core-shell nanoparticles of claim 1, wherein the TiO₂ is in an amorphous form and/or wherein the metal oxide comprised in the core is in a crystalline form and/or wherein the nanoparticles have a cube-like morphology.

6.-7. (canceled)

8. The core-shell nanoparticles of claim 1, wherein a M:Ti molar ratio is about 10:1 to about 0.5:1, preferably about 4:1 to about 0.7:1, preferably about 3:1 to about 0.7:1, and most preferably about 2:1 to about 0.8:1.

9. The core-shell nanoparticles of claim 1, wherein an average size of the core-shell nanoparticles is in a range from about 10 nm to about 500 nm, preferably about 75 nm to about 200 nm, and an average thickness of the shell of the core-shell particle is in a range of about 1 nm to about 50 nm, preferably about 5 nm to about 20 nm.

10. The core-shell nanoparticles of claim 1, wherein the elemental sulfur comprises sulfur nanocrystals.

11. A nanocomposite material comprising the core-shell nanoparticles as defined in claim 1 and a first conductive nanomaterial.

12. The nanocomposite material of claim 11, wherein the core-shell nanoparticles are supported on the first conductive material.

13. The nanocomposite material of claim 11, wherein the first conductive nanomaterial is a conductive nanocarbon nano-wire, nano-sheet, nano-belt, or a combination thereof.

14. The nanocomposite material of claim 11, wherein the first conductive nanomaterial is a reduced graphene oxide nanosheet or a graphene nanosheet of a lateral size of about 50 nm to about 500 nm, preferably 100 nm to about 200 nm.

15. The nanocomposite material of claim 11, wherein a weight ratio of the first conductive nanomaterial to the nanoparticles excluding sulfur is about 1:1 to about 1:10, preferably about 1:2 to about 1:4 and/or wherein a weight ratio of sulfur to the nanocomposite material excluding sulfur is about 10:1 to about 1:2, preferably about 3:1 to about 1:1.

16. (canceled)

17. A method for producing core-shell nanoparticles as defined in claim 1 or a nanocomposite material comprising the core-shell nanoparticles and a first conductive nanomaterial, the method comprising:
(a) contacting M_{y}(CO₃)ₓ nanoparticles with TiO₂ or a TiO₂ precursor to form TiO₂ coated M_{y}(CO₃)ₓ nanoparticles (M_{y}(CO₃)ₓ/TiO₂);
(b) thermally treating the M_{y}(CO₃)ₓ/TiO₂ nanoparticles from step (a) at elevated temperature under inert gas to form core-shell M_{y}Oₓ/TiO₂ nanoparticles;
(c) optionally thermally treating the core-shell M_{y}Oₓ/TiO₂ nanoparticles with a first conductive nanomaterial under inert gas at elevated temperature, optionally in the presence of hydrogen gas, to form a nanocomposite material;
(d) optionally partly removing M_{y}Oₓ after step (b) or (c) by treatment with an acid;
(e) milling the obtained nanoparticles or nanocomposite material of step (b), (c), or (d) with elemental sulfur (Ss) to produce a mixture; and
(f) heating the mixture obtained in step (e) at elevated temperature under inert gas to cause the sulfur to melt-diffuse into the pores of the nanoparticles and/or nanocomposite material.

18. (canceled)

19. The method of claim 17, wherein the TiO₂ precursor is at least one organotitanium compound selected from the group consisting of titanium tetraisopropoxide, titanium tetra-n-butoxide, titanium tetrakis(2-ethylhexyloxide), titanium tetrastearyloxide, titanium acetylacetonate, titanium ethyl acetoacetate, salicylaldehyde ethyleneimine titanate, diacetone alkoxy titanium, octylene glycoxy titanium, triethanolamine titanate, titanium lactate, monocyclopentadienyltitanium trihalides, dicyclopentadienyltitanium dihalides, cyclopentadienyltitanium trimethoxide, cyclopentadienyltitanium triethoxide, and cyclopentadienyltitanium tripropoxide.

20. (canceled)

21. The method of claim 17, wherein the nanoparticles or nanocomposite material before the milling step has specific surface area measured by Brunauer-Emmett-Teller (B.E.T.) of about 40 m²/g to about 150 m²/g, or of about 60 m²/g to about 120 m²/g, preferably about 80 m²/q to about 100 m²/g and/or wherein the acid is a mineral acid, preferably H₂SO₄ or HCl, preferably used in a concentration of 0.1 M to 5 M.

22. (canceled)

23. The method of claim 17, wherein each thermal treatment step is independently performed at a temperature of about 200° C. to about 500° C., preferably about 300° C. to about 400° C. and/or wherein the heating step is performed at a temperature of about 140° C. to about 180° C. for about 5 hours to about 48 hours.

24.-25. (canceled)

26. An electrode material comprising core-shell nanoparticles as defined in claim 1 or a nanocomposite material comprising said core-shell nanoparticles and a first conductive nanomaterial.

27. The electrode material of claim 26, further comprising a second conductive material, a binder, and optionally one or more additives.

28. The electrode material of claim 27, wherein the second conductive material is selected from the group consisting of carbon black, carbon Ketjen™ acetylene black, graphite, graphene, carbon fibers (such as carbon nanofibers or VGCF), carbon nanotubes, and a combination of at least two of these and/or wherein the binder material is selected from the group consisting of a polymeric binder of the polyether type, a fluoropolymer, a water-soluble binder, and a combination thereof.

29. (canceled)

30. The electrode material of claim 28, wherein the polyether type polymer binder is a linear, branched, and/or crosslinked polymer based on polyethylene oxide (PEO), poly(propylene oxide) (PPO) or a mixture of the two (or an EO/PO copolymer), and optionally comprises crosslinkable units or wherein the water-soluble binder is SBR (styrene-butadiene rubber), NBR (acrylonitrile-butadiene rubber), HNBR (hydrogenated NBR), or CHR (epichlorohydrin rubber) acrylate), optionally comprising CMC (carboxymethylcellulose.

31.-32. (canceled)

33. A positive electrode comprising the electrode material claim 26 on a current collector.

34. An electrochemical cell comprising the positive electrode as defined in claim 33, a negative electrode, and an electrolyte.

35. (canceled)

36. A lithium sulfur battery comprising at least one electrochemical cell as defined in claim 34.

37. A lithium sulfur battery comprising the core-shell nanoparticles as defined in claim 1 or a nanocomposite material comprising said core-shell nanoparticles and a first conductive nanomaterial.

38. (canceled)
